(19) United States
(12) Patent Application Publication
(10) Pub. No.: US 2020/0145807 A1
(43) Pub. Date: May 7, 2020

(54) EMERGENCY INFORMATION PROCESSING DEVICE, SYSTEM, METHOD, AND RECORDING MEDIUM

(71) Applicant: NEC Corporation, Minato-ku, Tokyo (JP)

(72) Inventors: Noriyuki HORIUCHI, Tokyo (JP); Shingo SHIGA, Tokyo (JP); Akihiko KAWAJIRI, Tokyo (JP); Satoshi KURODA, Tokyo (JP); Reiko MASUDA, Tokyo (JP)

(73) Assignee: NEC Corporation, Minato-ku, Tokyo (JP)

(21) Appl. No.: 16/619,514

(22) PCT Filed: Jun. 12, 2018
(86) PCT No.: PCT/JP2018/022430

§ 371 Date: Dec. 5, 2019

(30) Foreign Application Priority Data
Jun. 15, 2017 (JP) 2017-117701

(51) Int. Cl. H04W 4/90; H04W 4/06; H04W 24/10

(52) U.S. Cl. CPC H04W 4/90; H04W 24/10; H04W 4/06

(57) ABSTRACT

In order to enable to reduce an increase in traffic generated when emergency information is reported from a communication terminal to another communication terminal, an emergency information processing method includes: receiving emergency information from a communication terminal, determining a report destination depending on a reliability based on a number of receptions of the emergency information, and transmitting the emergency information to the report destination.

### TECHNICAL FIELD

The present invention relates to an emergency information processing device, a system, a method, and a recording medium that report emergency information transmitted by a communication terminal, to another communication terminal.

### BACKGROUND ART

As a method of reporting emergency information from a communication terminal to a peripheral communication terminal when an emergency such as a disease and an accident occurs, there are methods described, for example, in PTLs 1 and 2.

In the method described in PTL 1, when emergency information is transmitted from a certain communication terminal, a radio base station to which the communication terminal is connected reports, by broadcasting, emergency information to a communication terminal existing inside a coverage of the radio base station. Further, in the method described in PTL 2, a report destination of emergency information is expanded further to a communication terminal inside a coverage of a radio base station having an adjacent coverage.

However, in the methods described in PTLs 1 and 2, a report unit is a coverage of a radio base station. Therefore, it is difficult to freely set a report range. Further, while emergency information can be reported to a communication terminal subscribing to the same communication carrier as for a communication terminal of a report source, it is difficult to report emergency information to a communication terminal subscribing to another communication carrier.

Further, PTL 3 describes a method of reporting emergency information from a distribution source such as a disaster information distribution server to a communication terminal, and transmitting information of the communication terminal from the communication terminal having received the emergency information to an information collection server. In this method, a distribution device having received emergency information from the distribution source identifies a distribution area and transmits the emergency information to a radio base station, and the radio base station transmits the emergency information to the distribution area. Also, in this method, it is difficult to freely set a report range since the report range is a cell unit of a radio base station. Further, a report destination to which a distribution device reports emergency information is a communication terminal of the same communication carrier as for the distribution device.

In contrast, in a method described in PTL 4, a communication terminal of a transmission side transmits emergency information including local position information, a communication terminal having received the emergency information compares local position information with the position information of the communication terminal of the transmission side, and display for reporting an emergency occurrence is performed in a case of falling within a predetermined distance. Therefore, in this method, a report range can be specified based on a distance between communication terminals, instead of a coverage unit of a radio base station. Further, in this method, an emergency reporting processing device is connected to a network connection device of each communication carrier, and thereby emergency information can be transmitted to a communication terminal of each communication carrier.

### CITATION LIST

### Patent Literature

[PTL 1] Japanese Unexamined Patent Application Publication No. 2008-077562
[PTL 2] Japanese Unexamined Patent Application Publication No. 2010-193234
[PTL 3] Japanese Unexamined Patent Application Publication No. 2016-127522
[PTL 4] Japanese Unexamined Patent Application Publication No. 2007-074449

### Non Patent Literature

[NPL 1] “3GPP TS 23.041 V14.0.0”, September 2016, pp. 17 to 25

### SUMMARY OF INVENTION

### Technical Problem

However, in the method described in PTL 4, all pieces of emergency information are reported to each communication carrier. Therefore, due to reporting of emergency information, traffic is increased with respect to not only a communication carrier of a transmission source of the emergency information but also a communication carrier different from the communication carrier of the transmission source.

An object of the present invention is to provide an emergency information processing device, a system, a method, and a recording medium being capable of reducing an increase in traffic generated when emergency information is reported from a communication terminal to another communication terminal.

### Solution to Problem

To solve the above-mentioned problem, an emergency information processing device of the present invention comprises: an emergency information reception means for receiving emergency information from a communication terminal, a report destination determination means for determining a report destination depending on a reliability based on a number of receptions of the emergency information, and an emergency information transmission means for transmitting the emergency information to the report destination.

And, an emergency information processing method of the present invention comprises: receiving emergency information from a communication terminal, determining a report destination depending on a reliability based on a number of receptions of the emergency information, and transmitting the emergency information to the report destination.

And, a computer readable recording medium recorded with an emergency information processing program of the present invention, the program causing a computer to execute: an emergency information reception function of receiving emergency information from a communication terminal, a report destination determination function of determining a report destination depending on a reliability based on a number of receptions of the emergency information, and an emergency information transmission function of transmitting the emergency information to the report destination.

### Advantageous Effects of Invention

An increase in traffic generated when emergency information is reported from a communication terminal to another communication terminal can be reduced based on an emergency information processing device, a system, a method, and a recording medium according to the present invention.

### BRIEF DESCRIPTION OF DRAWINGS

FIG. 1 shows a diagram illustrating a configuration example of an emergency information processing device according to a first example embodiment of the present invention.

FIG. 2 shows a diagram illustrating an operation example of the emergency information processing device according to the first example embodiment of the present invention.

FIG. 3 shows a diagram illustrating a configuration example of an emergency information processing system according to a second example embodiment of the present invention.

FIG. 4 shows a diagram illustrating a configuration example of a communication terminal according to the second example embodiment of the present invention.

FIG. 5 shows a diagram illustrating a configuration example of a communication terminal according to the second example embodiment of the present invention.

FIG. 6 shows a diagram illustrating a reliability of the second example embodiment of the present invention.

FIG. 7 shows a diagram illustrating an operation example of an emergency information processing system according to the second example embodiment of the present invention.

FIG. 8 shows a diagram illustrating an operation example of an emergency information processing system according to the second example embodiment of the present invention.

FIG. 9 shows a diagram illustrating an operation example of an emergency information processing system according to the second example embodiment of the present invention.

FIG. 10 shows a diagram illustrating an operation example of an emergency information processing system according to the second example embodiment of the present invention.

FIG. 11 shows a diagram illustrating an operation example of an emergency information processing system according to the second example embodiment of the present invention.

FIG. 12 shows a diagram illustrating an operation example of an emergency information processing system according to a third example embodiment of the present invention.

FIG. 13 shows a diagram illustrating an operation example of an emergency information processing system according to the third example embodiment of the present invention.

FIG. 14 shows a diagram illustrating an operation example of an emergency information processing system according to the third example embodiment of the present invention.

FIG. 15 shows a diagram illustrating a hardware configuration example according to each example embodiment of the present invention.

### EXAMPLE EMBODIMENT

### First Example Embodiment

A first example embodiment of the present invention is described.

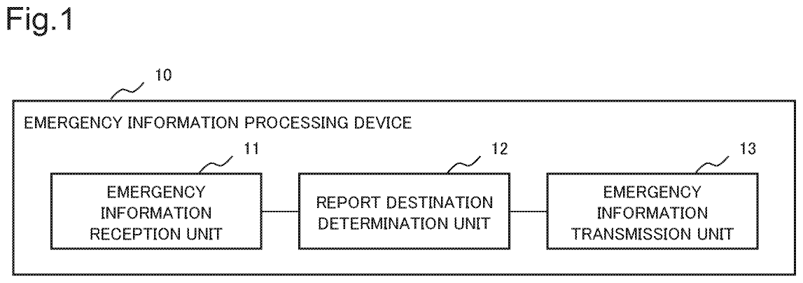

FIG. 1 illustrates a configuration example of an emergency information processing device 10 according to the present example embodiment. The emergency information processing device 10 according to the present example embodiment includes an emergency information reception unit 11, a report destination determination unit 12, and an emergency information transmission unit 13.

The emergency information reception unit 11 is a part for receiving emergency information from a communication terminal. The report destination determination unit 12 is a part for determining a report destination depending on a reliability based on the number of receptions of emergency information. The emergency information transmission unit 13 is a part for transmitting emergency information to the report destination.

When the emergency information processing device 10 is configured in this manner, the emergency information processing device 10 determines a report destination depending on a reliability based on the number of receptions of emergency information. Thus, a report destination of emergency information having a low reliability is narrowed down, and thereby an increase in traffic can be reduced. Therefore, an increase in traffic generated when emergency information is reported from a communication terminal to another communication terminal can be reduced.

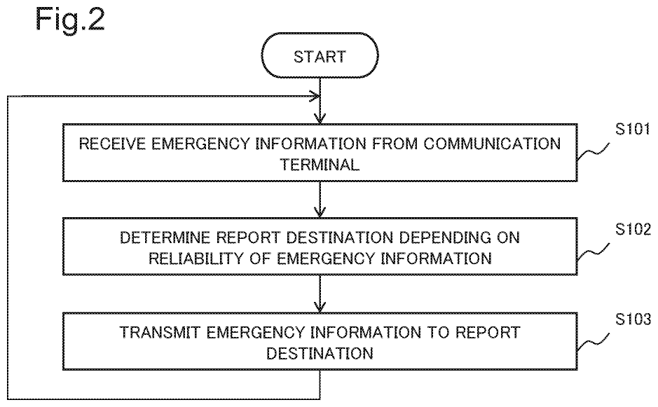

Next, FIG. 2 illustrates an operation example of the emergency information processing device 10 according to the present example embodiment.

First, the emergency information reception unit 11 receives emergency information from a communication terminal (step S101). Next, the report destination determination unit 12 determines a report destination depending on a reliability based on the number of repetitions of emergency information (step S102). The emergency information transmission unit 13 transmits emergency information to the report destination (step S103).

An operation is executed in this manner, and thereby the emergency information processing device 10 determines a report destination depending on a reliability based on the number of repetitions of emergency information. Thus, a report destination of emergency information having a low reliability is narrowed down, and thereby an increase in traffic can be reduced. Therefore, an increase in traffic generated when emergency information is reported from a communication terminal to another communication terminal can be reduced.

As described above, according to the first example embodiment of the present invention, the emergency information processing device 10 determines a report destination depending on a reliability based on the number of repetitions of emergency information. Thus, a report destination of emergency information having a low reliability is narrowed down, and thereby an increase in traffic can be reduced. Therefore, an increase in traffic generated when emergency information is reported from a communication terminal to another communication terminal can be reduced.

### Second Example Embodiment

Next, a second example embodiment of the present invention is described. According to the present example embodiment, an example in which a technique (NPL 1) of an earthquake and tsunami warning system (ETWS) in the Third Generation Partnership Project (3GPP) being a standard of a mobile communication system is used is described.

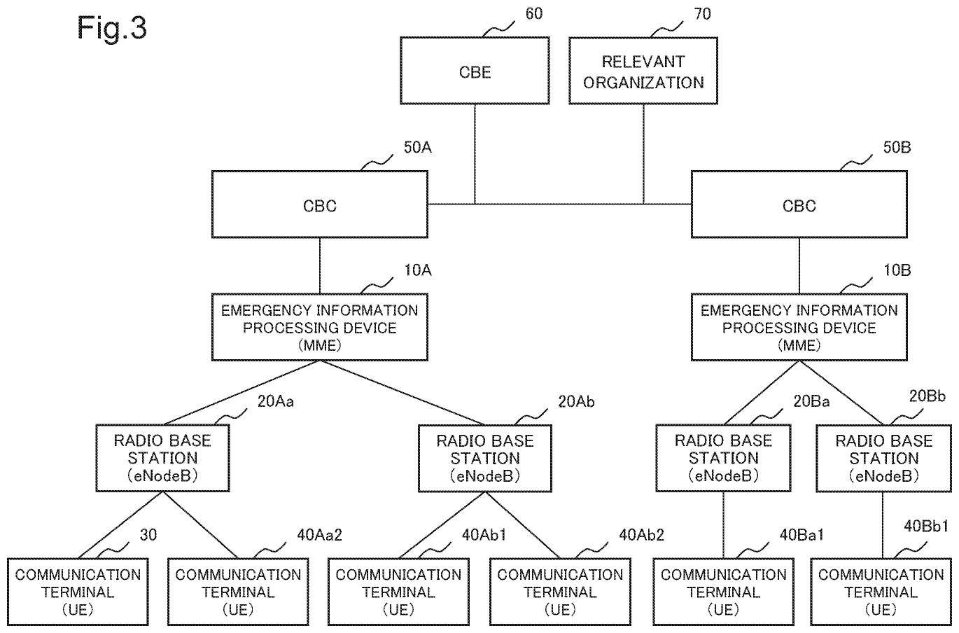

First, FIG. 3 illustrates a configuration example of an emergency information processing system according to the present example embodiment. The emergency information processing system according to the present example embodiment includes an emergency information processing device 10, a radio base station 20, a communication terminal 30, a communication terminal 40, a cell broadcast center (CBC) 50, a cell broadcast entity (CBE) 60, and a relevant organization 70. Any number being one or more devices is applicable to each device in a system.

The emergency information processing device 10 (10A, 10B) is a device that executes processing of reporting emergency information. According to the present example embodiment, while it is assumed that a mobile management entity (MME) includes an emergency information processing function, the CBC 50 may be an emergency information processing device 10 including an emergency information processing function. Further, the emergency information processing device 10 may be a device independent of an MME and a CBC. Further, according to the present example embodiment, it is assumed that communication carriers each include one MME (emergency information processing device 10).

The radio base station 20 (20Aa, 20Ab, 20Ba, 20Bb) is a radio base station in mobile communication and is, for example, an evolved NodeB (eNodeB). The radio base station 20 connects the communication terminal 30 and the communication terminal 40 to a core network.

The communication terminal 30 and the communication terminal 40 (40Aa2, 40Ab1, 40Ab2, 40Ba1, 40Bb1) are a communication terminal held by a user. The communication terminal 30 and the communication terminal 40 transmit/receive emergency information to/from the emergency information processing device 10 via the radio base station 20. According to the present example embodiment, it is assumed that the communication terminal 30 transmits emergency information and the communication terminal 40 receives emergency information.

The CBC 50 (50A, 50B) is an information distribution server in an ETWS. The CBE 60 is an information distribution source in the ETWS. Further, the relevant organization 70 is a report destination of emergency information of a relevant organization such as a police station, a fire station, and a hospital other than the communication terminal 40. The relevant organization 70 is, for example, a device that acquires biological information (e.g., a heart rate, a blood pressure, a temperature, a vibration, and the like) collected by the communication terminal 30 in order to determine a policy for coping with an emergency.

According to the present example embodiment, it is assumed that emergency information processing devices 10 (e.g., an emergency information processing device 10A and an emergency information processing device 10B) of different communication carriers transmit/receive emergency information via the CBE 60. Alternatively, information may be transmitted/received via a device, other than the CBE 60, such as a device (being connected to a CBC of each communication carrier) of an arbitration organization that coordinates emergency information services.

Further, while FIG. 3 illustrates a configuration example in which the present example embodiment is carried out by using an evolved universal terrestrial radio access network (E-UTRAN), the present example embodiment can be carried out by using Global System for Mobile communications (GSM: registered trademark) and Universal Mobile Telecommunications Systems (UMTS). In other words, when the present example embodiment is carried out by using GSM, an MME in FIG. 3 is a base station controller (BSC), an eNodeB is a base transceiver station (BTS), and user equipment (UE) is a mobile station (MS). Further, when the present example embodiment is carried out by using UMTS, an MME in FIG. 3 is a radio network controller (RNC) and an eNodeB is a NodeB.

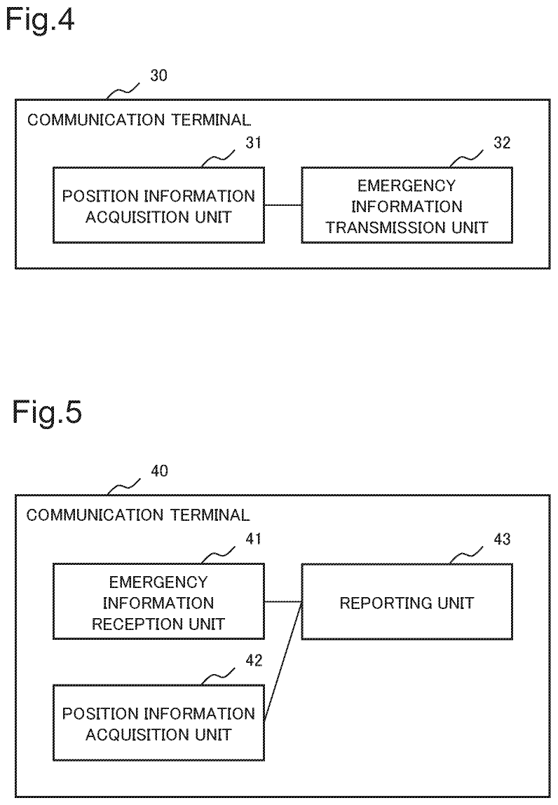

Next, FIG. 4 illustrates a configuration example of the communication terminal 30. The communication terminal 30 is a device that transmits emergency information. The communication terminal 30 includes a position information acquisition unit 31 and an emergency information transmission unit 32.

The position information acquisition unit 31 is a part for acquiring position information of the communication terminal 30. The emergency information transmission unit 32 is a part for transmitting, when an emergency occurs, emergency information to the emergency information processing unit 10A via the radio base station 20Aa. According to the present example embodiment, the emergency information transmission unit 32 transmits emergency information including the position information of the communication terminal 30. Further, the emergency information transmission unit 32 may transmit emergency information that includes a report range desired by a user, a transmission time of emergency information, and an occurrence time of an emergency.

Further, the communication terminal 30 may include an emergency detection function of detecting an emergency by using various types of sensors for an acceleration, a pressure, a sound, a temperature, a humidity, vital information (heart rate), and the like, and the emergency information transmission unit 32 may transmit emergency information when the emergency detection function detects an emergency. Alternatively, the emergency information transmission unit 32 may transmit emergency information by an operation of a user or in cooperation with another wearable device or the like.

Next, FIG. 5 illustrates a configuration example of the communication terminal 40. The communication terminal 40 is a device that receives emergency information. The communication terminal 40 includes an emergency information reception unit 41, a position information acquisition unit 42, and a reporting unit 43. The communication terminal 30 may include a function of the communication terminal 40, and the communication terminal 40 may include a function of the communication terminal 30.

The emergency information reception unit 41 is a part for receiving emergency information from the emergency information processing device 10 via the radio base station 20.

The position information acquisition unit 42 is a part for acquiring position information of the communication terminal 40.

The reporting unit 43 is a part for reporting reception of emergency information to a user by using a buzzer sound, displaying a message, or the like. The reporting unit 43 compares position information of the communication terminal 30 being a transmission source of emergency information included in received emergency information with position information of the communication terminal 40 and reports reception of emergency information when a distance between the communication terminal 30 and the communication terminal 40 falls within a predetermined report range.

The reporting unit 43 may previously store, by setting of a user or the like, a range of the communication terminal 30 to which the reporting unit 43 reports emergency information and report an emergency when the communication terminal 30 is located in the range. Alternatively, the reporting unit 43 may report, when emergency information includes a report range, an emergency when the communication terminal 40 is located in the report range. Alternatively, the reporting unit 43 may report an emergency when a report range included in emergency information and a report range stored in the communication terminal 40 are compared and another communication terminal is included in any one of the report ranges. Further, the reporting unit 43 may previously store an upper-limit value of a report range determined by a communication carrier and determine, when a report range determined based on a report range included in emergency information or a report range stored in the communication terminal 40 is larger than the upper-limit value, the upper-limit value as a report range. Further, an upper-limit value may be received from the emergency information processing device 10.

Next, by using FIG. 1, the emergency information processing device 10 (10A, 10B) is described.

The emergency information reception unit 11 is a part for receiving emergency information from the communication terminal 30. The emergency information transmission unit 13 is a part for transmitting emergency information to a report destination.

The report destination determination unit 12 is a part for determining a report destination depending on a reliability based on the number of receptions of emergency information. A reliability is an indicator indicating whether emergency information is not an erroneous report but is reliable. The report destination determination unit 12 estimates a reliability, based on the number of receptions of emergency information and determines a larger number of report destinations as a reliability of emergency information increases.

More specifically, the report destination determination unit 12 determines, when, for example, a reliability is larger than a first threshold, a report destination as a first communication device managed by the emergency information processing device 10 itself. The first communication device is, for example, a radio base station 20 of the same communication carrier as for each of the emergency information processing devices 10.

According to the present example embodiment, it is assumed that the first communication device is a radio base station 20 of a communication carrier of the emergency information processing devices 10 itself. The report destination determination unit 12 according to the present example embodiment determines, as a first communication device, a radio base station 20 having, as a coverage, a predetermined report range from a position of the communication terminal 30, in such a way as to be able to report emergency information to a communication terminal 40 located in a report range from the position of the communication terminal 30.

The report destination determination unit 12 of the emergency information processing device 10A determines, for example, the radio bases station 20Aa and the radio base station 20Ab as a report destination (first communication device) when the communication terminal 40Aa2 and the communication terminal 40Ab1 are located in a report range. The emergency information transmission unit 13 transmits emergency information to the radio bases station 20Aa and the radio base station 20Ab. The radio bases station 20Aa having received the emergency information transmits emergency information to the communication terminal 30 and the communication terminal 40Aa2, and the radio base station 20Ab transmits emergency information to the communication terminal 40Ab1 and the communication terminal 40Ab2.

The report destination determination unit 12 may receive a report range from the communication terminal 30. Further, the report destination determination unit 12 may determine, when a report range received from the communication terminal 30 is wider than a predetermined upper-limit value, the upper-limit value as a report range.

Further, the report destination determination unit 12 further adds, when a reliability is larger than a second threshold, a second communication device different from the first communication device to the report destination. The second communication device is, for example, an emergency information processing device 10 managed by another communication carrier and the relevant organization 70. For example, in a case of the emergency information processing device 10A, the emergency information processing device 10B and the relevant organization 70 are added to the report destination.

The number of thresholds with respect to reliability is not limited to two. For example, a third threshold larger than a first threshold and smaller than a second threshold and a fourth threshold large than a second threshold may be provided. When a reliability is larger than a first threshold, a radio base station 20 (radio base station 20Aa) to which the communication terminal 30 is connected may be added as a report destination, and when a reliability is larger than a third threshold, a radio base station 20 (radio base station 20Ab) of the same communication carrier may be added as the report destination. Further, when a reliability is larger than a second threshold, the relevant organization 70 may be added to the report destination, and when a reliability is larger than a fourth threshold, an emergency information processing device 10 (emergency information processing device 10B) of another communication carrier may be added to the report destination.

Further, the report destination determination unit 12 according to the present example embodiment calculates a reliability when receiving emergency information. The report destination determination unit 12 determines, for example, past emergency information similar to latest emergency information, based on a reception time of emergency information, a transmission time, an occurrence time of an emergency, and a position of the communication terminal 30 and determines the number of receptions of past similar emergency information as a reliability.

The report destination determination unit 12 compares, when receiving emergency information, for example, a position of the communication terminal 30 with respect to each of combinations of emergency information received within a predetermined time in a past and latest emergency information. The number of combinations in which a distance between a position of the communication terminal 30 of the latest emergency information and a position of the communication terminal 30 of the past emergency information is equal to or smaller than a predetermined value is determined as a reliability. By doing so, a reliability increases when a large number of pieces of emergency information are generated in a periphery of the communication terminal 30.

Further, the report destination determination unit 12 may calculate a reliability by using a method described below. In this method, an event identification (ID) is provided to a group of similar emergency information, and when emergency information is received, the number of receptions for the event ID is counted.

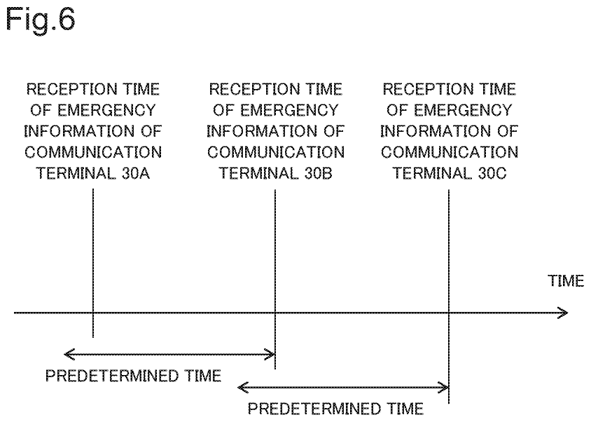

It is assumed that the emergency information processing device 10 determines, when, for example, reception times of pieces of emergency information fall within a predetermined time and the communication terminal 30 is located in a predetermined range, that the pieces of emergency information are similar and further reports to another communication carrier when a reliability is equal to or larger than 2. It is assumed that the emergency information processing device 10 receives emergency information from three communication terminals 30 (30A, 30B, 30C) (all of the three communication terminals 30 existing in a predetermined range one another) as in FIG. 6.

At that time, first, the report destination determination unit 12 does not receive, when receiving emergency information from the communication terminal 30A, similar emergency information within a predetermined time, and therefore delivers a new event ID (designated as an event ID-a) and determines a reliability of the event ID-a as 1. Further, the report destination determination unit 12 determines a report destination of the emergency information of the communication terminal 30A as a radio base station 20 of the communication carrier of the emergency information processing device 10 itself, and the emergency information transmission unit 13 transmits the emergency information of the communication terminal 30A to the radio base station 20 of the communication carrier of the emergency information processing device 10 itself.

Next, the report destination determination unit 12 counts up, when receiving emergency information from the communication terminal 30B, the reliability of the event ID-a to 2 since the emergency information is similar to the emergency information of the communication terminal 30A. Further, the report destination determination unit 12 determines a report destination of the emergency information of the communication terminal 30B as the radio base station 20 and another communication carrier, the radio base station 20 being the radio base station 20 of the communication carrier of the emergency information processing device 10 itself, and the emergency information transmission unit 13 transmits the emergency information of the communication terminal 30B to the radio base station 20 and another communication carrier, the radio base station 20 being the radio base station 20 of the communication carrier of the emergency information processing device 10 itself.

Further, at that time, the report destination determination unit 12 adds, since the reliability of the event ID-a is 2, another communication carrier to the report destination also with respect to the emergency information of the communication terminal 30A associated with the event ID-a, and the emergency information transmission unit 13 transmits the emergency information of the communication terminal 30A to another communication carrier.

Next, the report destination determination unit 12 delivers, when receiving emergency information from the communication terminal 30C, a new event ID (designated as an event ID-b) since the emergency information is similar to the emergency information of the communication terminal 30B but is not similar to the emergency information of the communication terminal 30A and determines a reliability as 2. Further, the report destination determination unit 12 determines a report destination of the emergency information of the communication terminal 30C as the radio base station 20 and another communication carrier, the radio base station 20 being the radio base station 20 of the communication carrier of the emergency information processing device 10 itself, and the emergency information transmission unit 13 transmits the emergency information of the communication terminal 30C to the radio base station 20 and another communication carrier, the radio base station 20 being the radio base station 20 of the communication carrier of the emergency information processing device 10 itself.

In this method, also with regard to emergency information received within a predetermined time, when a reliability increases, emergency information can be reported to another communication carrier.

Further, the report destination determination unit 12 may calculate a reliability, based on the number of receptions of the same emergency information. At that time, the communication terminal 30 repeatedly transmits the same emergency information until a stop operation is executed based on a predetermined time or by a user. In this case, for example, as time spent until an emergency situation is resolved and transmission of emergency information is stopped is longer, a reliability increases.

Further, the emergency information reception unit 11 may execute, when receiving emergency information, user authentication of the communication terminal 30, based on a usable/unusable flag. It is assumed that a usable/unusable flag is previously set by a communication carrier, based on information about whether to be a user able to use a report service of emergency information and about a past usage result, e.g., whether to be a user having sent an illegal report (a mischief or the like) in a past.

When the emergency information processing device 10 is configured in this manner, the emergency information processing device 10 determines a report destination depending on a reliability based on the number of receptions of emergency information. Thus, a report destination of emergency information having a low reliability is narrowed down, and thereby an increase in traffic can be reduced. Therefore, an increase in traffic generated when emergency information is reported from a communication terminal to another communication terminal can be reduced.

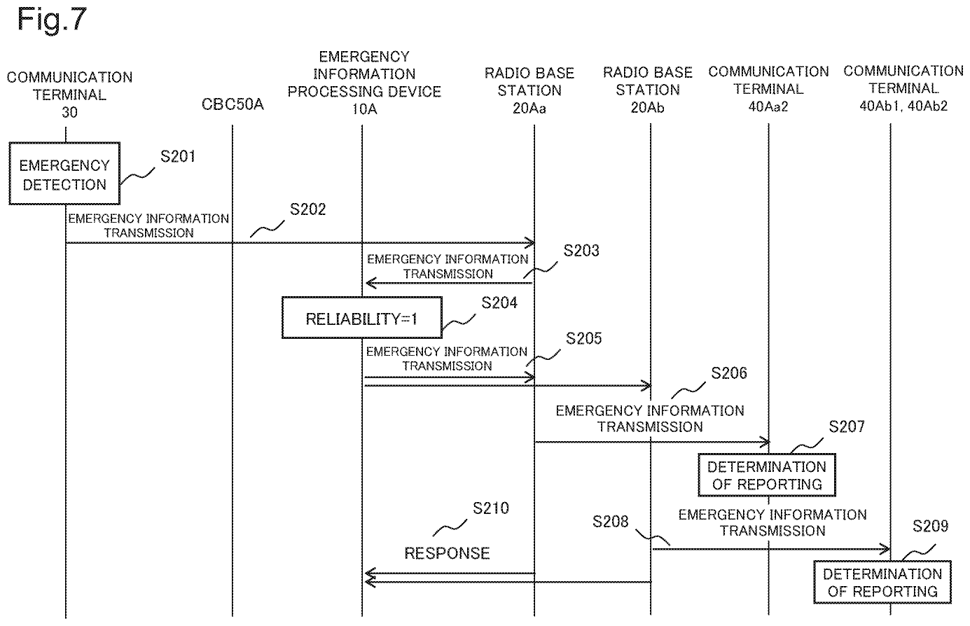

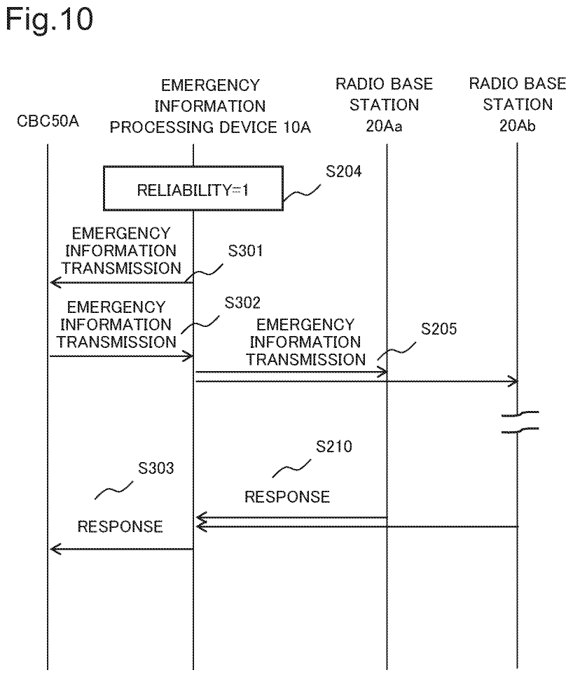

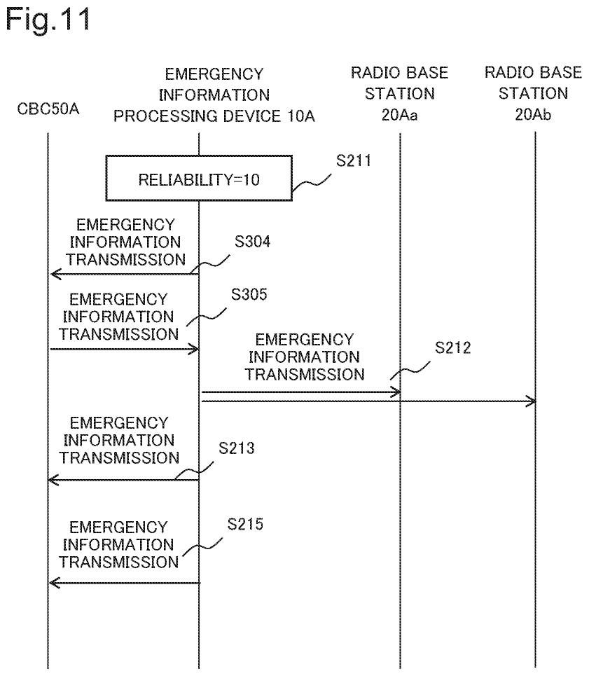

Next, by using FIGS. 7 to 11, an operation example of the emergency information processing system according to the present example embodiment is described. The operation example of the emergency information reporting system according to the present example embodiment includes two patterns in which emergency information is reported to an MME and emergency information is reported to a CBC. FIGS. 7 to 9 each are the operation examples in which emergency information is reported to the MME, and FIGS. 10 to 11 each are the operation examples in which emergency information is reported to the CBC.

When emergency information is reported to the MME, time spent until the communication terminal 40 reports can be reduced, compared with a case of reporting to the CBC. Further, when emergency information is reported to the CBC, a sequence conforms to a standard of an ETWS, and therefore the present example embodiment can be easily carried out by expanding the ETWS technique. Further, according to the present example embodiment, description has been made, assuming that the MME is the emergency information processing device 10, but the CBC can be the emergency information processing device 10.

It is assumed that the emergency information processing device 10A transmits, when a reliability is equal to or larger than 1, emergency information into the same communication carrier and transmits, when a reliability is equal to or larger than 10, emergency information toward a relevant organization 70 and another communication carrier.

First, by using FIGS. 7 to 9, the operation example in which emergency information is reported to the MME is described.

The communication terminal 30 transmits, when detecting an emergency (step S201 in FIG. 7), emergency information to the emergency information processing device 10A via the radio base station 20Aa (step S202, step S203). At that time, the communication terminal 30 transmits emergency information including position information of the communication terminal 30 itself, time information of a time at which an emergency occurs, and information relating to a report range and a content of the emergency. It is assumed that the report range is previously set for the communication terminal 30 by a user of the communication terminal 30. Further, it is assumed that, according to the present example embodiment, the report range is a distance from the communication terminal 30, i.e., a radius of a circle around the communication terminal 30, but a shape of the report range may not necessarily be a circle but may be any shape.

The emergency information processing device 10A having received emergency information confirms whether the communication terminal 30 can use an emergency information service. The emergency information processing device 10A determines a reliability when the communication terminal 30 can use an emergency information service. It is assumed that the reliability determined by the emergency information processing device 10A is 1 (step S204).

The emergency information processing device 10A determines, since the reliability is 1, a report destination as a radio base station 20 of the same communication carrier. At that time, the emergency information processing device 10A first determines, when a report range included in emergency information is larger than an upper-limit value of the report range previously set for the emergency information processing device 10A, a report range as the upper-limit value. The emergency information processing device 10A determines a radio base station 20 to which emergency information is reported, based on the report range, position information included in emergency information, and a coverage of each of radio base stations 20.

Herein, it is assumed that the communication terminal 40Aa2 and the communication terminal 40Ab1 are located in the report range. Therefore, the emergency information processing device 10A transmits emergency information to the radio base station 20Aa and a radio base station 20Ab (step S205). At that time, the emergency information processing device 10A transmits, for example, a Write-Replace Warning Request message and position information of the communication terminal 30, time information of a time at which an emergency occurs, and information relating to the report range and a content of the emergency. Further, an upper-limit value of a report range determined by a communication carrier may be transmitted from the emergency information processing device 10A to the radio base station 20.

While according to NPL 1, a CBC generates an ETWS message, according to the present example embodiment, a transmission source of emergency information is the communication terminal 30. Therefore, the communication terminal 30 may generate a Write-Replace Warning Request message.

The radio base station 20Aa and the radio base station 20Ab having received emergency information transmit emergency information to a managed communication terminal 40 by broadcasting (step S206, step S208). At that time, the radio base station 20Aa and the radio base station 20Ab transmit, for example, a Cell Broadcast delivery message and position information of the communication terminal 30, time information of a time at which an emergency situation occurs, and information relating to the report range and a content of the emergency (while the radio base station 20Aa transmits emergency information also to the communication terminal 30, the communication terminal 30 is a transmission source of emergency information and therefore neglects received emergency information). Further, the radio base station 20Aa and the radio base station 20Ab respond to the emergency information processing device 10A after transmitting emergency information (step S210). The radio base station 20Aa and the radio base station 20Ab transmit, for example, a Write-Replace Warning Response message.

The communication terminal 40Aa2, the communication terminal 40Ab1, and the communication terminal 40Ab2 having received emergency information determine whether to report the emergency information to a user (step S207, step S209). At that time, each communication terminal 40 determines whether to report the emergency information to a user, based on a position of the communication terminal 30, a report range included in the emergency information, a position of the communication terminal 40 itself, and the report range set for the communication terminal 40 itself. The communication terminal 40Aa2 and the communication terminal 40Ab1 are located in the report range and therefore report the emergency information to a user by using a buzzer sound. The communication terminal 40Ab2 is located outside the report range and therefore does not report.

At that time, the communication terminal 40 may determine, when the report range is wider that an upper-limit value previously set by a communication carrier, the upper-limit value as a report range. Further, an upper-limit value may be received from the emergency information processing device 10A via the radio base station 20.

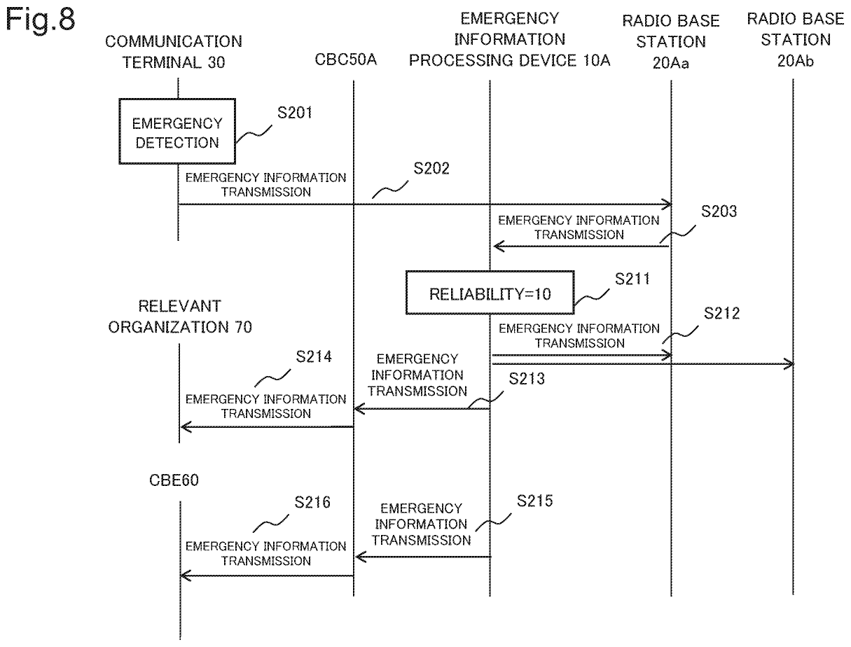

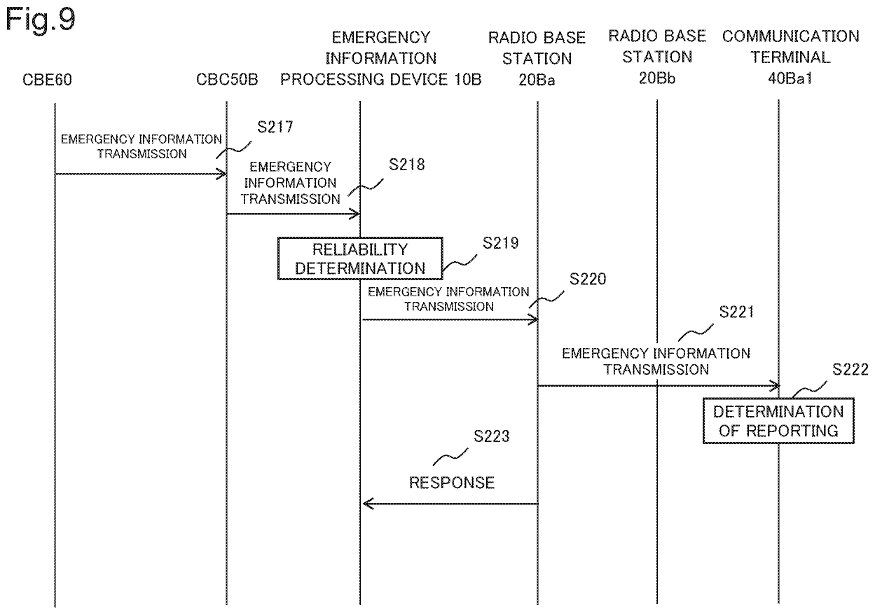

FIGS. 8 and 9 each are an operation example of the emergency information processing system in which a reliability calculated by the emergency information processing device 10A is 10. Step S201 to step S203 are similar to FIG. 7.

When a reliability is 10 (step S211), the emergency information processing device 10A adds the relevant organization 70 and the CBE 60 to the report destination. The emergency information processing device 10A transmits emergency information to the radio base station 20Aa and the radio base station 20Ab (step S212). Then, the emergency information processing system executes an operation similar to step S206 to step S210 in FIG. 7.

Further, the emergency information processing device 10A transmits the emergency information to the relevant organization 70 and the CBE 60 via the CBC 50A (step S213 to step S216).

The CBE 60 having received the emergency information transmits the emergency information to the emergency information processing device 10B via the CBC 50B (step S217 and step S218 in FIG. 9). When there are a plurality of emergency information processing devices 10 under control of the CBC 50B, after step S218, the CBC 50B determines an emergency information processing device 10 being a transmission destination of the emergency information, based on position information of the communication terminal 30, the report range, and a coverage of a radio base station 20 under control.

The emergency information processing device 10B having received the emergency information determines, depending on a reliability included in the emergency information, whether to report the emergency information (step S219). The emergency information processing device 10B determines, when determining to report, a radio base station 20 being a report destination, based on a position of the communication terminal 30, a report range, an upper-limit value of a report range previously set for the emergency information processing device 10B, and a coverage of the radio base station 20 under control. It is assumed that the emergency information processing device 10B determines the radio base station 20Ba as a report destination. The emergency information processing device 10B transmits emergency information to the radio base station 20Ba (step S220).

The radio base station 20Ba having received the emergency information transmits the emergency information to a managed communication terminal 40Ba1 (step S221). A response is transmitted to the emergency information processing device 10B (step S223).

The communication terminal 40Ba1 having received the emergency information determines whether to report, based on position information included in the emergency information, a report range included in the emergency information, position information of the communication terminal 40Ba1 itself and a report range of the communication terminal 40Ba1 itself, and reports when determining to report (step S222).

Next, by using FIGS. 10 and 11, the operation example in which emergency information is transmitted to the CBC is described. FIG. 10 is a difference from FIG. 7, and FIG. 11 is a difference from FIG. 8.

After step S204 in FIG. 7, the emergency information processing device 10A transmits emergency information to the CBC 50A (step S301 in FIG. 10).

The CBC 50A having received the emergency information determines an emergency information processing device 10 being a transmission destination of the emergency information among emergency information processing devices 10 of the same communication carrier, based on position information included in the emergency information, a report range included in the emergency information, and a coverage of a radio base station 20 under control. The emergency information (e.g., a Write Replace Warning Request) is transmitted to the determined emergency information processing device 10 (herein, the emergency information processing device 10A) (step S302). Further, the emergency information processing device 10A issues a response (e.g., a Write Replace Warning Response) to the CBC 50A. The emergency information processing device 10A transmits, similarly to step S205 in FIG. 7, the emergency information to the radio base station 20Aa and the radio base station 20Ab.

Further, the emergency information processing device 10A issues, when receiving the response to the emergency information transmission (step S210 in FIG. 7) from the radio base station 20Aa and the radio base station 20Ab, a response (e.g., a Write Replace Warning Indication) to the CBC 50A (step S303 in FIG. 10).

Further, after step S211 in FIG. 8, the emergency information processing device 10A transmits the emergency information to the CBC 50A (step S304 in FIG. 11). The CBC 50A having received the emergency information determines an emergency information processing device 10 being a transmission destination of the emergency information among emergency information processing devices 10 of the same communication carrier, based on position information included in the emergency information, a report range included in the emergency information, and a coverage of a radio base station 20 under control. The emergency information is transmitted to the determined emergency information processing device 10 (herein, the emergency information processing device 10A) (step S305).

An operation is executed in such a manner, and thereby the emergency information processing device 10 determines a report destination depending on a reliability based on the number of receptions of emergency information. Thus, a report destination of emergency information having a low reliability is narrowed down, and thereby an increase in traffic can be reduced. Therefore, an increase in traffic generated when emergency information is reported from a communication terminal to another communication terminal can be reduced.

As described above, according to the second example embodiment of the present invention, the emergency information processing device 10 determines a report destination depending on a reliability based on the number of receptions of emergency information. Thus, a report destination of emergency information having a low reliability is narrowed down, and thereby an increase in traffic can be reduced. Therefore, an increase in traffic generated when emergency information is reported from a communication terminal to another communication terminal can be reduced.

An emergency information reporting function described according to the present example embodiment can be used for advertisement distribution and the like, in addition to reporting of emergency information.

### Third Example Embodiment

Next, a third example embodiment of the present invention is described. According to the present example embodiment, a case where emergency information is canceled is described. A cancellation of emergency information is made based on an operation of a communication terminal 30 by a user or the like, when emergency information is erroneously transmitted from the communication terminal 30, for example, by an erroneous operation, when an emergency situation is resolved and a rescue is unnecessary, or the like.

First, by using FIG. 1, a configuration example of an emergency information processing device 10 of the present example embodiment is described. A configuration example of the emergency information processing device 10 according to the present example embodiment is similar to the second example embodiment. Reporting of emergency information is similar to the second example embodiment, and therefore description is omitted.

An emergency information reception unit 11 according to the present example embodiment further receives a cancellation report for emergency information from a communication terminal 30.

Further, a report destination determination unit 12 according to the present example embodiment further determines, as a transmission destination of a cancellation report, a report destination of emergency information of a communication terminal 30 being a transmission source of the cancellation report. Specifically, the report destination determination unit 12 stores, for example, an association relation between information of a communication terminal 30 being a transmission source of past emergency information and a reliability, and determines, as a transmission destination of a cancellation report, a report destination associated with a reliability associated with the communication terminal 30 being a transmission source of the cancellation report.

An emergency information transmission unit 13 according to the present example embodiment further transmits a cancellation report to a transmission destination determined by the report destination determination unit 12.

The emergency information processing device 10 is configured in such a manner, and thereby the emergency information processing device 10 determines a report destination depending on a reliability based on the number of receptions of emergency information. Thus, a report destination of emergency information having a low reliability is narrowed down, and thereby an increase in traffic can be reduced. Therefore, an increase in traffic generated when emergency information is reported from a communication terminal to another communication terminal can be reduced.

Further, the emergency information processing device 10 according to the present example embodiment receives a cancellation report from the communication terminal 30 and transmits the received cancellation report to the report destination of emergency information. Therefore, reporting of emergency information can be canceled.

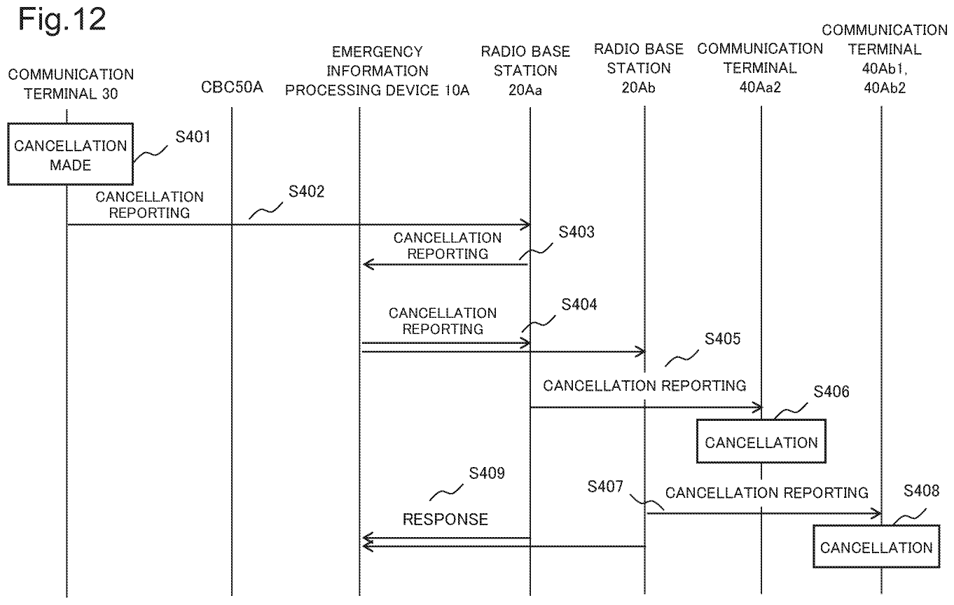

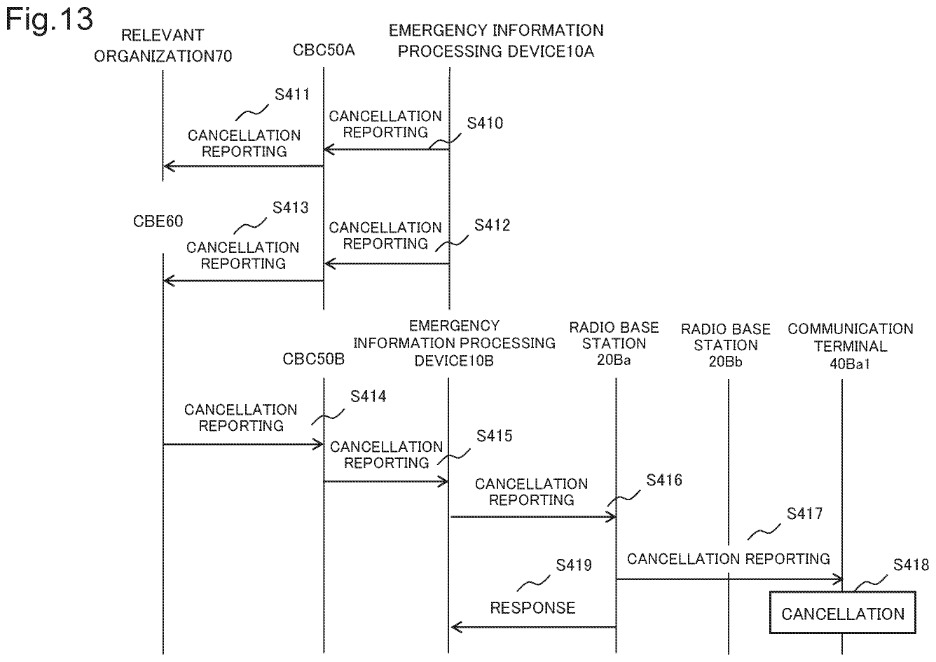

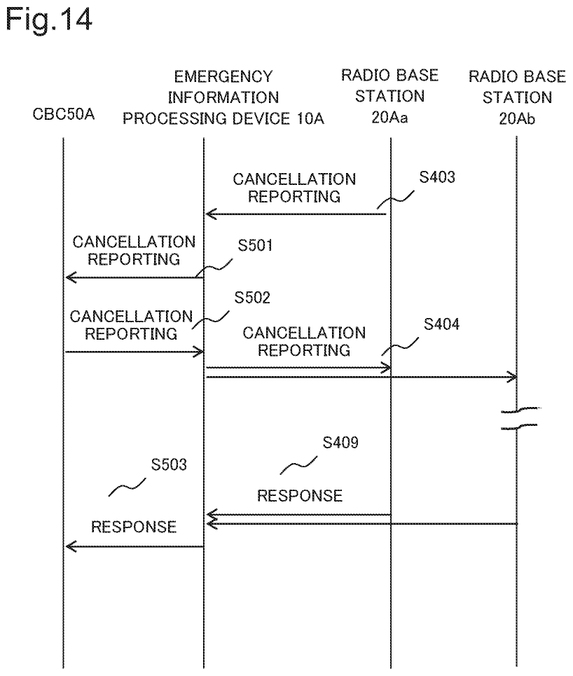

Next, FIGS. 12 to 14 each illustrate an operation example of the emergency information processing system according to the present example embodiment. The operation example of the emergency information reporting system according to the present example embodiment includes two patterns in which emergency information is reported to an MME and emergency information is reported to a CBC. FIGS. 12 to 13 each are the operation examples in which emergency information is reported to the MME, and FIG. 14 is the operation example in which emergency information is reported to the CBC.

Reporting of emergency information is similar to the second example embodiment and therefore description is omitted, and an example of a cancellation operation is described herein.

First, the operation example in which emergency information is reported to the MME is described.

A communication terminal 30 transmits, when a cancellation is made (S401 in FIG. 12), a cancellation report to an emergency information processing device 10A via a radio base station 20Aa (step S402, step S403).

The emergency information processing device 10A having received the cancellation report transmits the cancelation report to the report destination of emergency information transmitted by the communication terminal 30 being a transmission source of the cancellation report (step S404). The emergency information processing device 10A transmits the cancellation report to a radio base station 20Aa and a radio base station 20Ab. Further, at that time, the emergency information processing device 10A transmits, for example, a Kill Request message and information for identifying emergency information to be canceled. As information for identifying emergency information to be canceled, an ID uniquely assigned to emergency information or an ID uniquely assigned to a communication terminal 30 is conceivable and is assumed to be transmitted to a communication terminal 40, another communication carrier, and a relevant organization 70 at a time of transmitting emergency information.

The radio base station 20Aa and the radio base station 20Ab having received the cancellation report transmit the cancellation report to a managed communication terminal 40 by broadcasting (step S405, step S407). At that time, the radio base station 20Aa and the radio base station 20Ab transmit, for example, a Stop Cell Broadcast delivery message and information for identifying emergency information to be canceled.

Further, the radio base station 20Aa and the radio base station 20Ab respond to the emergency information processing device 10A after transmitting the cancelation report (step S409). The radio base station 20Aa and the radio base station 20Ab transmit, for example, a Kill Response message.

A communication terminal 40Aa2, a communication terminal 40Ab1, and a communication terminal 40Ab2 having received the cancellation report, when having already reported emergency information to be canceled to a user, report that a cancellation has been made (step S406, step S408) (the radio base station 20Aa transmits the cancellation report also to the communication terminal 30 but the communication terminal 30 is a transmission source of the cancellation report and therefore neglects the received cancellation report). When the emergency information to be canceled is not reported, the communication terminal 40 reports neither the emergency information to be canceled nor the cancellation.

When emergency information has been transmitted to another communication carrier and a relevant organization 70, the emergency information processing device 10A transmits the cancellation report to the relevant organization 70 and a CBE 60 via a CBC 50A (step S410 to step S413 in FIG. 13).

The CBE 60 having received a cancellation report transmits emergency information to an emergency information processing device 10B via a CBC 50B (step S414, step S415). The emergency information processing device 10B transmits the cancellation report to a radio base station 20, herein, a radio base station 20Ba, being a transmission destination of emergency information to be canceled (step S416).

The radio base station 20Ba having received the cancellation report transmits the cancellation report to a managed communication terminal 40Ba1 (step S417). A response is transmitted to the emergency information processing device 10B (step S419).

The communication terminal 40Ba1 having received the cancellation report reports, when having already reported emergency information to be canceled, a cancellation of the emergency information to a user (step S418).

Next, by using FIG. 14, the operation example in which emergency information is transmitted to the CBC is described. FIG. 14 is a difference from FIG. 12.

After step S403 in FIG. 12, the emergency information processing device 10A transmits the cancellation report to the CBC 50A (step S501 in FIG. 14).

The CBC 50A having received the cancellation report transmits the cancelation report (e.g., a Stop Warning Request) to the emergency information processing device 10 (herein, the emergency information processing device 10A) being a transmission destination of emergency information to be cancelled (step S502). Further, the emergency information processing device 10A issues a response (e.g., a Stop Warning Confirm) to the CBC 50A. The emergency information processing device 10A transmits, similarly to step S404 in FIG. 12, the cancellation report to the radio base station 20Aa and the radio base station 20Ab.

Further, the emergency information processing device 10A issues, when receiving a response to emergency information transmission from the radio base station 20Aa and the radio base station 20Ab, a response (e.g., a Stop Warning Indication) to the CBC 50A (step S503 in FIG. 14).

A cancellation operation can be used in order to reduce an erroneous report of emergency information due to an erroneous operation of the communication terminal 30 by a user.

For example, the emergency information processing device 10 inquires of the communication terminal 30 about whether the emergency information is correct, when receiving emergency information from the communication terminal 30. When the communication terminal 30 transmits a cancellation report by an operation of a user or the like, the emergency information processing device 10 executes a cancellation operation.

An operation is executed in this manner, and thereby the emergency information processing device 10 determines a report destination depending on a reliability based on the number of receptions of emergency information. Thus, a report destination of emergency information having a low reliability is narrowed down, and thereby an increase in traffic can be reduced. Therefore, an increase in traffic generated when emergency information is reported from a communication terminal to another communication terminal can be reduced.

As described above, according to the third example embodiment of the present invention, the emergency information processing device 10 determines a report destination depending on a reliability based on the number of receptions of emergency information. Thus, a report destination of emergency information having a low reliability is narrowed down, and thereby an increase in traffic can be reduced. Therefore, an increase in traffic generated when emergency information is reported from a communication terminal to another communication terminal can be reduced.

Further, the emergency information processing device 10 according to the present example embodiment receives a cancellation report from the communication terminal 30 and transmits the cancellation report to the report destination of emergency information. Therefore, reporting of emergency information can be canceled.

[Hardware Configuration Example]

A configuration example of a hardware resource which implements, by use of one information processing device (computer), the emergency information processing device (10) in each example embodiment of the present invention described above is described. Note that the emergency information processing device may be physically or functionally implemented by use of at least two information processing devices. Moreover, the emergency information processing device may be implemented as a dedicated device. Further, only some functions of the emergency information processing device may be implemented by use of an information processing device.

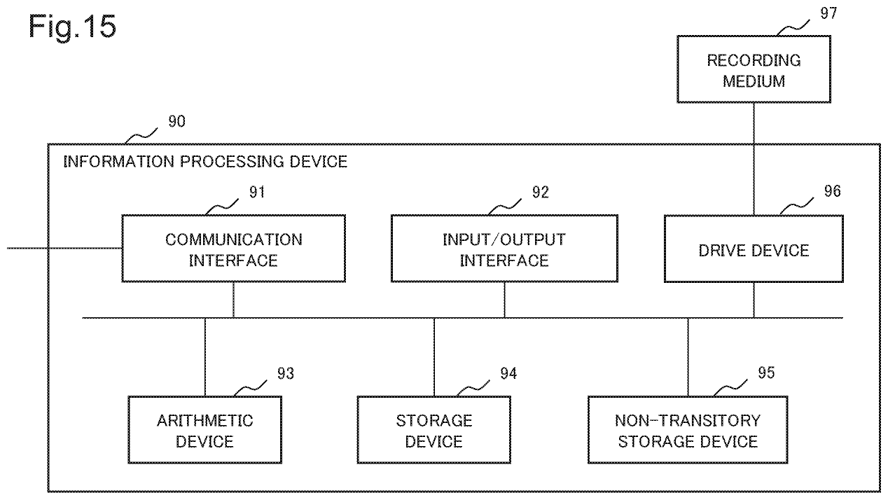

FIG. 15 is a diagram schematically showing a hardware configuration example of an information processing device being capable of implementing the emergency information processing device in each example embodiment of the present invention. An information processing device 90 includes a communication interface 91, an input/output interface 92, an arithmetic device 93, a storage device 94, a non-volatile storage device 95, and a drive device 96.

The communication interface 91 is a communication means with which the emergency information processing device in each example embodiment communicates with an external device in a wired or wireless way. Note that, when the emergency information processing device is implemented by use of at least two information processing devices, the devices may be connected to each other in such a way as to be able to mutually communicate via the communication interface 91.

The input/output interface 92 is a man machine interface such as a keyboard being one example of an input device, or a display as an output device.

The arithmetic device 93 is an arithmetic processing device such as a general-purpose central processing unit (CPU) or a microprocessor. The arithmetic device 93 can read, for example, various programs stored in the non-volatile storage device 95, into the storage device 94, and execute processing in accordance with the read program.

The storage device 94 is a memory device such as a random access memory (RAM) which can be referred to from the arithmetic device 93, and stores a program, various data, and the like. The storage device 94 may be a volatile memory device.

The non-volatile storage device 95 is a non-volatile storage device such as a read only memory (ROM), a flash memory, or the like, and can store various programs, data, and the like.

The drive device 96 is, for example, a device which processes reading and writing of data from and into a recording medium 97 described later.

The recording medium 97 is any recording medium such as an optical disk, a magneto-optical disk, a semiconductor flash memory or the like being capable of recording data.

Each example embodiment of the present invention may be implemented by, for example, configuring a emergency information processing device by the information processing device 90 exemplified in FIG. 15, and supplying this emergency information processing device with a program being capable of implementing a function described in each of the example embodiments described above.

In this case, the arithmetic device 93 executes the program supplied to the emergency information processing device, and thereby, an example embodiment can be implemented. Moreover, not all but some of the functions of the emergency information processing device can be configured by the information processing device 90.

Furthermore, the present invention may be configured in such a way that the program described above is recorded in the recording medium 97, and appropriately stored in the non-volatile storage device 95 at a shipment stage, an operation stage, or the like of the emergency information processing device. Note that, in this case, a method of installing the program described above into the emergency information processing device by utilizing a suitable jig at a manufacturing stage before shipment, an operation stage, or the like may be adopted as a method of supplying the program described above. Moreover, a general procedure such as a method of externally downloading the program described above via a communication line such as the Internet may be adopted as a method of supplying the program described above.

The whole or part of the example embodiments disclosed above can be described as, but not limited to, the following supplementary notes.

(Supplementary Note 1)

An emergency information processing device comprising:

an emergency information reception means for receiving emergency information from a communication terminal;

a report destination determination means for determining a report destination depending on a reliability based on a number of receptions of the emergency information; and

an emergency information transmission means for transmitting the emergency information to the report destination.

(Supplementary Note 2)

The emergency information processing device according to supplementary note 1, wherein

the report destination determination means determines a larger number of the report destinations as the reliability increases.

(Supplementary Note 3)

The emergency information processing device according to supplementary note 2, wherein

the report destination determination means determines, when the reliability is larger than a first threshold, the report destination as a first communication device managed by the emergency information processing device, and further adds, when the number of receptions is larger than a second threshold, a second communication device different from the first communication device to the report destination.

(Supplementary Note 4)

The emergency information processing device according to supplementary note 3, wherein

the first communication device is a radio base station having, as a coverage, a predetermined report range from a position of the communication terminal.

(Supplementary Note 5)

The emergency information processing device according to any one of supplementary notes 1 to 4, wherein

the report destination determination means determines the past emergency information similar to the latest emergency information, based on any one or more of a reception time of the emergency information, a transmission time of the emergency information, an occurrence time of the emergency information at the communication terminal, and a position of the communication terminal, and determines the number of receptions of the past similar emergency information as the reliability.

(Supplementary Note 6)

The emergency information processing device according to any one of supplementary notes 1 to 5, wherein

the emergency information reception means further receives a cancellation report with respect to the emergency information, and

the emergency information transmission means further transmits the cancellation report to the report destination of the emergency information.

(Supplementary Note 7)

An emergency information processing system comprising:

the emergency information processing device according to any one of supplementary notes 1 to 6;

the communication terminal; and

the report destination.

(Supplementary Note 8)

An emergency information processing method comprising:

receiving emergency information from a communication terminal;

determining a report destination depending on a reliability based on a number of receptions of the emergency information; and

transmitting the emergency information to the report destination.

(Supplementary Note 9)

The emergency information processing method according to supplementary note 8, further comprising

determining a larger number of the report destinations as the reliability increases.

(Supplementary Note 10)

The emergency information processing method according to supplementary note 9, further comprising:

determining, when the reliability is larger than a first threshold, the report destination as a first communication device managed by an emergency information processing device, and further adding, when the number of receptions is larger than a second threshold, a second communication device different from the first communication device to the report destination.

(Supplementary Note 11)

The emergency information processing method according to supplementary note 10, wherein

the first communication device is a radio base station having, as a coverage, a predetermined report range from a position of the communication terminal.

(Supplementary Note 12)

The emergency information processing method according to any one of supplementary notes 8 to 11, further comprising:

determining the past emergency information similar to the latest emergency information, based on any one or more of a reception time of the emergency information, a transmission time of the emergency information, an occurrence time of the emergency information at the communication terminal, and a position of the communication terminal, and determining the number of receptions of the past similar emergency information as the reliability.

(Supplementary Note 13)

The emergency information processing method according to any one of supplementary notes 8 to 12, further comprising:

receiving a cancellation report with respect to the emergency information; and

transmitting the cancellation report to the report destination of the emergency information.

(Supplementary Note 14)

A non-transitory computer readable recording medium recorded with an emergency information processing program causing a computer to execute:

an emergency information reception function of receiving emergency information from a communication terminal;

a report destination determination function of determining a report destination depending on a reliability based on a number of receptions of the emergency information; and

an emergency information transmission function of transmitting the emergency information to the report destination.

(Supplementary Note 15)

The non-transitory computer readable recording medium recorded with the emergency information processing program according to supplementary note 14, wherein

the report destination determination function determines a larger number of report destinations as the reliability increases.

(Supplementary Note 16)

The non-transitory computer readable recording medium recorded with the emergency information processing program according to supplementary note 15, wherein

the report destination determination function determines, when the reliability is larger than a first threshold, the report destination as a first communication device managed by an emergency information processing device, and further adds, when the number of receptions is larger than a second threshold, a second communication device different from the first communication device to the report destination.

(Supplementary Note 17)

The non-transitory computer readable recording medium recorded with the emergency information processing program according to supplementary note 16, wherein

the first communication device is a radio base station having, as a coverage, a predetermined report range from a position of the communication terminal.

(Supplementary Note 18)

The non-transitory computer readable recording medium recorded with the emergency information processing program according to any one of supplementary notes 14 to 17, wherein

the report destination determination function determines the past emergency information similar to the latest emergency information, based on any one or more of a reception time of the emergency information, a transmission time of the emergency information, an occurrence time of the emergency information at the communication terminal, and a position of the communication terminal, and determines the number of receptions of the past similar emergency information as the reliability.

(Supplementary Note 19)

The non-transitory computer readable recording medium recorded with the emergency information processing program according to any one of supplementary notes 14 to 18, wherein

the emergency information reception function further receives a cancellation report with respect to the emergency information, and

the emergency information transmission function further transmits the cancellation report to the report destination of the emergency information.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2017-17701, filed on Jun. 15, 2017, the disclosure of which is incorporated herein in its entirety by reference.

### REFERENCE SIGNS LIST

10 Emergency information processing device
11 Emergency information reception unit
12 Report destination determination unit
13 Emergency information transmission unit
20 Radio base station
30 Communication terminal
31 Position information acquisition unit
32 Emergency information transmission unit
40 Communication terminal
41 Emergency information reception unit
42 Position information acquisition unit
43 Reporting unit
50 CBC
60 CBE
70 Relevant organization
90 Information processing device
91 Communication interface
92 Input/output interface
93 Arithmetic device
94 Storage device
95 Non-transitory storage device
96 Drive device
97 Recording medium

What is claimed is:

1. An emergency information processing device comprising one or more memories storing instructions and one or more processors configured to execute the instructions to:
receive emergency information from a communication terminal;
determine a report destination depending on a reliability based on a number of receptions of the emergency information; and
transmit the emergency information to the report destination.

2. The emergency information processing device according to claim 1, wherein
the one or more processors configured to execute the instructions to determine a larger number of the report destinations as the reliability increases.

3. The emergency information processing device according to claim 2, wherein
the one or more processors configured to execute the instructions to determine, when the reliability is larger than a first threshold, the report destination as a first communication device managed by the emergency information processing device, and further adds, when the number of receptions is larger than a second threshold, a second communication device different from the first communication device to the report destination.

4. The emergency information processing device according to claim 3, wherein
the first communication device is a radio base station having, as a coverage, a predetermined report range from a position of the communication terminal.

5. The emergency information processing device according to claim 1, wherein
the one or more processors configured to execute the instructions to determine the past emergency information similar to the latest emergency information, based on any one or more of a reception time of the emergency information, a transmission time of the emergency information, an occurrence time of the emergency information at the communication terminal, and a position of the communication terminal, and determines the number of receptions of the past similar emergency information as the reliability.

6. The emergency information processing device according to claim 1, wherein
the one or more processors configured to execute the instructions to
receive a cancellation report with respect to the emergency information, and
transmit the cancellation report to the report destination of the emergency information.

7. (canceled)

8. An emergency information processing method comprising:
receiving emergency information from a communication terminal;
determining a report destination depending on a reliability based on a number of receptions of the emergency information; and
transmitting the emergency information to the report destination.

9. The emergency information processing method according to claim 8, further comprising
determining a larger number of the report destinations as the reliability increases.

10. The emergency information processing method according to claim 9, further comprising:
determining, when the reliability is larger than a first threshold, the report destination as a first communication device managed by an emergency information processing device, and further adding, when the number of receptions is larger than a second threshold, a second communication device different from the first communication device to the report destination.

11. The emergency information processing method according to claim 10, wherein
the first communication device is a radio base station having, as a coverage, a predetermined report range from a position of the communication terminal.

12. The emergency information processing method according to claim 8, further comprising:
determining the past emergency information similar to the latest emergency information, based on any one or more of a reception time of the emergency information, a transmission time of the emergency information, an occurrence time of the emergency information at the communication terminal, and a position of the communication terminal, and determining the number of receptions of the past similar emergency information as the reliability.

13. The emergency information processing method according to claim 8, further comprising:
receiving a cancellation report with respect to the emergency information; and
transmitting the cancellation report to the report destination of the emergency information.

14. A non-transitory computer readable recording medium recorded with an emergency information processing program causing a computer to execute:
an emergency information reception function of receiving emergency information from a communication terminal;
a report destination determination function of determining a report destination depending on a reliability based on a number of receptions of the emergency information; and
an emergency information transmission function of transmitting the emergency information to the report destination.

15. The non-transitory computer readable recording medium recorded with the emergency information processing program according to claim 14, wherein
the report destination determination function determines a larger number of report destinations as the reliability increases.

16. The non-transitory computer readable recording medium recorded with the emergency information processing program according to claim 15, wherein
the report destination determination function determines, when the reliability is larger than a first threshold, the report destination as a first communication device managed by an emergency information processing device, and further adds, when the number of receptions is larger than a second threshold, a second communication device different from the first communication device to the report destination.

17. The non-transitory computer readable recording medium recorded with the emergency information processing program according to claim 16, wherein
the first communication device is a radio base station having, as a coverage, a predetermined report range from a position of the communication terminal.

18. The non-transitory computer readable recording medium recorded with the emergency information processing program according to claim 14, wherein
the report destination determination function determines the past emergency information similar to the latest emergency information, based on any one or more of a reception time of the emergency information, a transmission time of the emergency information, an occurrence time of the emergency information at the communication terminal, and a position of the communication terminal, and determines the number of receptions of the past similar emergency information as the reliability.

19. The non-transitory computer readable recording medium recorded with the emergency information processing program according to claim 14, wherein
the emergency information reception function further receives a cancellation report with respect to the emergency information, and
the emergency information transmission function further transmits the cancellation report to the report destination of the emergency information.
